(19) United States
(12) Patent Application Publication
(10) Pub. No.: US 2013/0010782 A1
(43) Pub. Date: Jan. 10, 2013

(54) METHOD AND APPARATUS FOR PERSISTENT ANCHORING OF INTERNET PROTOCOL DEVICES

(75) Inventor: Patrick Jensen, Fresno, CA (US)

(73) Assignee: CISCO TECHNOLOGY, INC., San Jose, CA (US)

(21) Appl. No.: 13/177,564

(22) Filed: Jul. 7, 2011

(51) Int. Cl. H04L 12/66

(52) U.S. Cl. 370/352

(57) ABSTRACT

In one embodiment, a method includes detecting a presence of a first endpoint on a port, and determining when the first endpoint is of a first type after detecting the presence of the first endpoint on the port. The port is associated with a switch that is part of a network and has a fixed address. The switch is arranged to support the first type. The method also includes mapping the first endpoint to the fixed address when it is determined that the endpoint is of the first type, wherein mapping the endpoint to the fixed address includes identifying the first endpoint by the fixed address within the network.

### TECHNICAL FIELD

The disclosure relates generally to telephony and unified communications. More particularly, the disclosure relates to a method and apparatus for enabling endpoints to be mapped to a consistent address for efficient integration of the endpoints into an Internet Protocol (IP) communications network.

### BACKGROUND

Many enterprises, e.g., health care institutions, utilize disposable analog phone devices attached to analog voice gateways in Voice over Internet Protocol (VoIP) environments, e.g., unified communications environments. Due to the need to control the spread of bacterial and viral infections in a health care environment, and the nature of plastics used to manufacture the analog phone devices, heath care institutions regularly discard analog phone devices. For example, when a previous patient vacates a hospital room and a new patient is slated to inhabit that hospital room, the analog phone device used by the previous patient is discarded and the new patient is given a new analog phone device.

In lieu of using disposable analog phone devices attached to analog voice gateways in VoIP environments, some enterprises such as health care institutions utilize VoIP phone devices in the VoIP environments, and dispose of the VoIP phone devices on a relatively regular basis. However, the costs associated with replacing VoIP phone devices relatively frequently may be relatively high. Each new VoIP phone device that is incorporated into a VoIP environment generally requires provisioning, as for example by information technology staff, due to each VoIP phone device having a hardware-specific media access control (MAC) address. The information technology staff generally logs onto a computer system to enter information associated with a VoIP phone in order to provision, e.g., configure, the VoIP phone for use on a VoIP network. The labor costs associated with provisioning each new VoIP phone device are generally relatively substantial, and often serve to deter enterprises in which phone devices are frequently replaced from utilizing VoIP phone devices.

### BRIEF DESCRIPTION OF THE DRAWINGS

The disclosure will be readily understood by the following detailed description in conjunction with the accompanying drawings in which:

FIG. 1 is a block diagram representation of an overall network in which a device is mapped to a fixed port address in accordance with an embodiment.

FIG. 2 is a process flow diagram which illustrates a method of incorporating a device, e.g., a new device, into an overall network in which the device is mapped to a fixed port address in accordance with an embodiment.

FIG. 3 is a process flow diagram which illustrates a method which enables a switch to incorporate a device, e.g., a new device, into an overall network in accordance with an embodiment.

FIG. 4 is a diagrammatic representation of a process of incorporating a device with a unique identifier into an overall network substantially without having to provision the device in accordance with an embodiment.

FIG. 5 is a block diagram representation of a switch that is capable of mapping a device with a unique identifier to a fixed port address in accordance with an embodiment.

### DESCRIPTION OF EXAMPLE EMBODIMENTS

### General Overview

According to one aspect, a method includes detecting a presence of a first endpoint on a port, and determining when the first endpoint is of a first type after detecting the presence of the first endpoint on the port. The port is associated with a switch that is part of a network and has a fixed address. The switch is arranged to support the first type. The method also includes mapping the first endpoint to the fixed address when it is determined that the endpoint is of the first type, wherein mapping the endpoint to the fixed address includes identifying the first endpoint by the fixed address within the network.

### Description

Phone devices used in some Voice over Internet Protocol (VoIP) environments are replaced fairly often. For example, phone devices used at a health care institution are replaced on a regular basis in order to minimize the risk of bacterial and viral infections being transferred from patient to patient. Disposable analog phone devices, coupled to analog voice gateways, are often implemented with respect to VoIP environments in health care institutions, as analog phone devices are relatively inexpensive and relatively easy to replace. As VoIP phone devices are generally more costly to incorporate due in large part to the amount of time associated with provisioning the VoIP phone devices, enterprises such as health care institutions which frequently replace phone devices may often elect to maintain analog phone devices. In general, analogy phone devices may be swapped relatively easily swapped, whereas VoIP phone devices are relatively time-consuming to swap.

By providing functionality that allows a VoIP phone device to be incorporated into a VoIP environment substantially without having to provision the VoIP phone device, the VoIP phone device may be efficiently incorporated into the VoIP environment. In one embodiment, a new VoIP phone device that has a unique media access control (MAC) address may be connected to a VoIP network through a port that has a fixed address, and the VoIP phone device may be substantially mapped to the port such that the fixed address is used to identify the VoIP phone. A switch may determine when a VoIP phone device is connected or otherwise in communication with a port that has a fixed address, and may map or anchor the VoIP phone device to the fixed address such that the VoIP phone device is effectively identified throughout a VoIP network by the fixed address. Thus, the need to provision the VoIP phone device once the VoIP phone device is connected to a port may be substantially eliminated, as a switch that detects the presence of the VoIP phone device may substantially automatically map the VoIP phone device to a fixed address of the port, thereby effectively incorporating the VoIP phone device into a VoIP network. Any compatible VoIP phone device that is connected to the port may be substantially automatically anchored to the port and, therefore, identified within the VoIP network by the fixed address of the port rather than by the MAC address of the VoIP phone device. As a result, VoIP phone devices may be efficiently swapped and/or replaced.

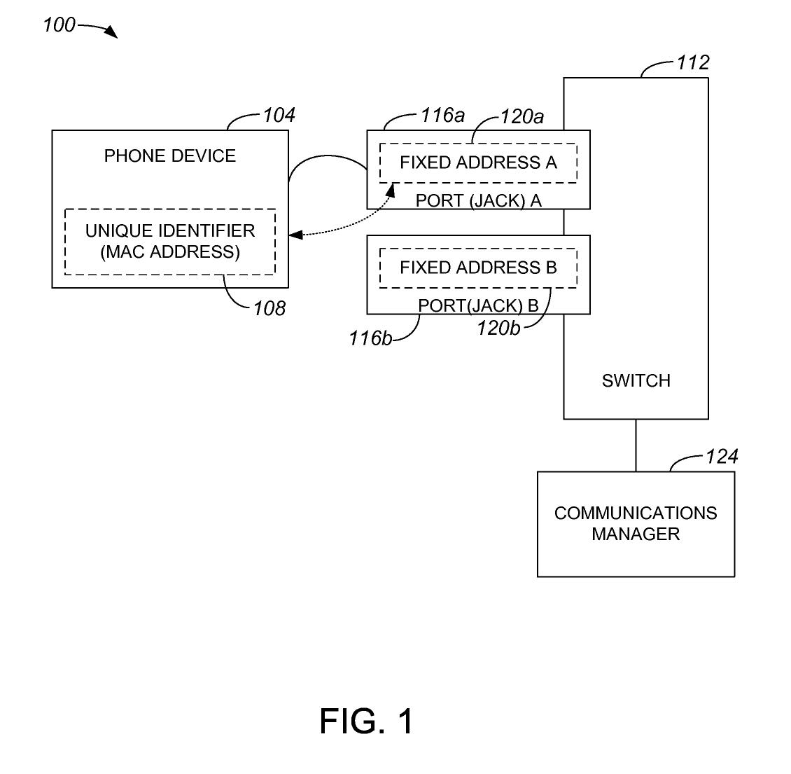

Referring initially to FIG. 1, an overall network, e.g., a VoIP network, in which a device, e.g., a VoIP phone device, is mapped to a fixed port address will be described in accordance with an embodiment. An overall network 100 includes a phone device 104, a switch 112, and at least one port 116a, 116b. A communications manager 124 that is arranged to process communications, e.g., IP telephony calls, within network 100 is also included in network 100. Communications manager 124 may be, in one embodiment, a Unified Communications Manager available from Cisco Systems, Inc. of San Jose, Calif. A Unified Communications Manager provides telephony features within network 100, and also provides video, mobility, presence, preference, and conference services within network 100.

Phone device 104 may be a VoIP phone device, e.g., a Cisco 6900 series IP phone available from Cisco Technology, Inc. It should be appreciated, however, that phone device 104 may generally be any apparatus that includes functionality that allows the apparatus to provide IP phone capabilities. Phone device 104 has a unique identifier 108, as for example a MAC address, that uniquely identifies phone device 104 within network 100. In one embodiment, unique identifier 108 is a globally unique identifier.

Switch 112 is associated with a plurality of ports 116a, 116b. Each port 116a, 116b has a fixed address 120a, 120b, respectively. Fixed address 120a uniquely identifies port 116a, while fixed address 120b uniquely identifies port 116b. As shown, phone device 104 is connected to port 120a. Switch 112 is arranged to detect the presence of phone device 104 when phone device is initially connected to port 120a. It should be appreciated that although no device is shown as being connected to port 120b, switch 112 is also arranged to detect the presence of any device (not shown) connected to port 120b.

Upon detecting the presence of phone device 104 connected to port 116a, switch 112 may effectively anchor phone device 104 to port 116a. Anchoring phone device 104 to port 116a generally entails mapping phone device 104 to port 116a such that phone device 104 is identified within network 100 by fixed address 120a, and such that phone device 104 is effectively not identified within network 110 using unique identifier 108. Hence, once phone device 104 is anchored to port 118a, communications manager 124 essentially addresses phone device 104 using fixed address 120a.

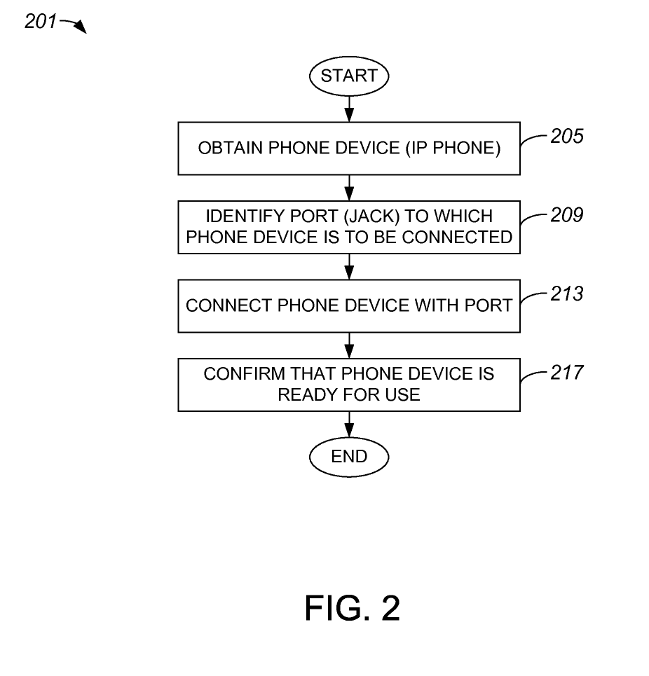

With reference to FIG. 2, a method of incorporating a phone device, e.g., a new IP phone device, into an overall network in which the phone device is mapped to a fixed port address by a switch will be described in accordance with an embodiment. It should be appreciated that although incorporating a phone device into a network is described, substantially any endpoint, e.g., IP endpoint, may generally be incorporated. A method 201 of incorporating phone device into an overall network, e.g., a VoIP network, begins at step 205 in which the phone device is obtained. In a health care environment, a new phone device may be obtained for use in a patient room as a part of a process of preparing the patient room to accept a new patient.

Once the phone device is obtained, a port to which the phone device is to be connected is identified in step 209. The port may be a jack that the phone device may be connected to or, more generally, communicably coupled to in order to interface with a network. After the port to which the phone device is to be connected is identified, the phone device is connected with the port in step 213. In one embodiment, connecting the phone device to the port may include interfacing the phone device to the port using a connector such as a cable.

A confirmation that the phone device is ready for use is performed in step 217, upon connecting the phone device with the port. As previously mentioned, a switch effectively automatically configures the phone device for use once the phone device is detected as being connected to the port by mapping a fixed address of the port to the phone device. Thus, confirming that the phone device is ready for use typically does not include manually provisioning the phone device, and may include, but is not limited to including, lifting a receiver of the phone device to determine whether a dial tone is heard and/or determining if a display of the phone device indicates that the phone device is ready for use. In one embodiment, confirming that the phone device is ready for use may include ascertaining whether a display of the phone device and a soft button layout indicate the extension, e.g., phone number, of a previously provisioned phone. It should be appreciated that when the phone device is ready for use, substantially all IP phone provisioning, speed dial phone numbers, and soft key configurations may effectively be transferred to the phone device, e.g., from a phone device that was previously connected to the port. Once the phone device is confirmed as being ready for use, the method of incorporating a phone device into an overall network is completed.

A switch in an overall network such as a VoIP network may, upon detecting the presence of a new phone device in the overall network, effectively anchor the phone device to a port. For example, if a switch detects a phone device of a particular type which has a MAC address of XX:XX:XX:X2:22:01 on a first port which has a fixed address of XX:XX:XX:X0:00:01, the switch may map or substantially anchor the phone device to the fixed address such that the phone device is effectively identified within a network as having the fixed address of XX:XX:XX:X0:00:01, and is not identified within the network by the MAC address of XX:XX:XX:X2:22:01. As such, any phone device of the particular type that is connected to the first port is mapped to the fixed address of the first port, and is not identified in the overall network by its MAC address.

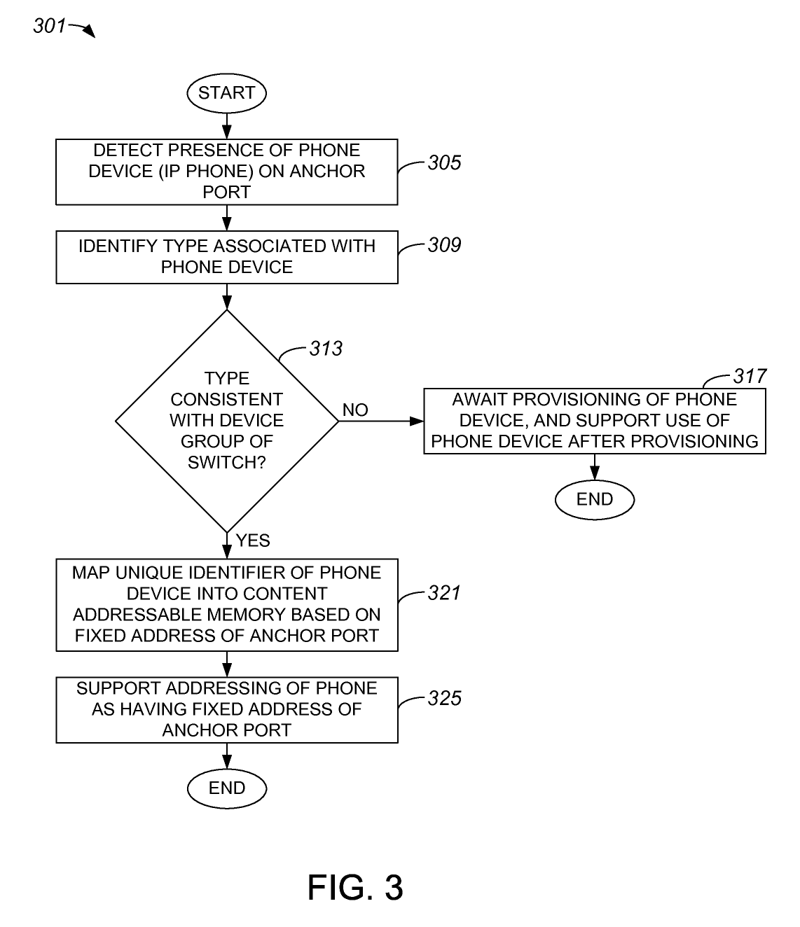

FIG. 3 is a process flow diagram which illustrates a method which enables a switch to incorporate a phone device, e.g., a new phone device, into an overall network in accordance with an embodiment. A process 301 of incorporating a phone device into a network from the point of view of a switch in the network begins at step 305 in which the switch detects the presence of a phone device or, more generally, an endpoint, on an anchor port. In one embodiment, the switch may detect the presence of the phone device using a discovery protocol, as for example a Cisco Discovery Protocol (CDP) developed by Cisco Systems, Inc. of San Jose, Calif. By way of example, identifying CDP type-length-value fields of the switch may enable the presence of phone devices that are of a device group supported by the switch to be detected. In one embodiment, within a predetermined amount of time, e.g., approximately sixty seconds, of an IP phone being plugged into a network, a CDP announcement may be received from the IP phone on a switch. Such a CDP announcement may include a type-length-value field that identifies the IP phone and an associated vendor, and may also provide confirmation that the switch will essentially anchor the IP hone with a predefined MAC address.

In step 309, a type associated with the phone device is identified. The type associated with the phone device is arranged to provide an indication, e.g., to the switch, that the phone device supports functionality that enables the phone device to be mapped to a fixed address of an anchor port. In one embodiment, the type associated with the phone device enables the phone device to be substantially automatically configured for use once the phone device is mapped to the fixed address of the anchor port, i.e., without the need for a manual provisioning process performed by a network administrator.

A determination is made in step 313 as to whether the type associated with the phone device is consistent with a device group supported by the switch. In other words, it is determined in step 313 whether the phone device may be substantially automatically configured for use once the phone device is mapped to a fixed address of an anchor port. If it is determined in step 313 that the type associated with the phone device is not consistent with the device group supported by the switch, the indication is that a manual provisioning process may be needed in order to configure the phone for use within the network, and that the phone device is to be identified by its unique identifier, e.g., MAC address. Accordingly, process flow moves from step 313 to step 317 in which the switch awaits manual provisioning of the phone and supports the use of the phone device after the phone device is provisioned. After the phone device is provisioned and the use of the phone device is supported, the process of incorporating a phone device into a network is completed.

Alternatively, if it is determined in step 313 that the type associated with the phone device is consistent with the device group supported by the switch, the unique identifier of the phone device is mapped into content addressable memory of the switch based on the fixed address of the anchor port in step 321. That is, the phone device is effectively anchored to or tied to the anchor port such that the phone device is substantially recognized within the network as having the fixed address of the anchor port. When the phone device is identified within the network as having the fixed address of the anchor port, the unique identifier of the phone device, e.g., the MAC address of the phone device, is essentially not seen within the network. Once the phone device is mapped to the fixed address of the anchor port, the addressing of the phone is supported in step 325 as having the fixed address of the anchor port, and the process of incorporating a phone device into a network is completed.

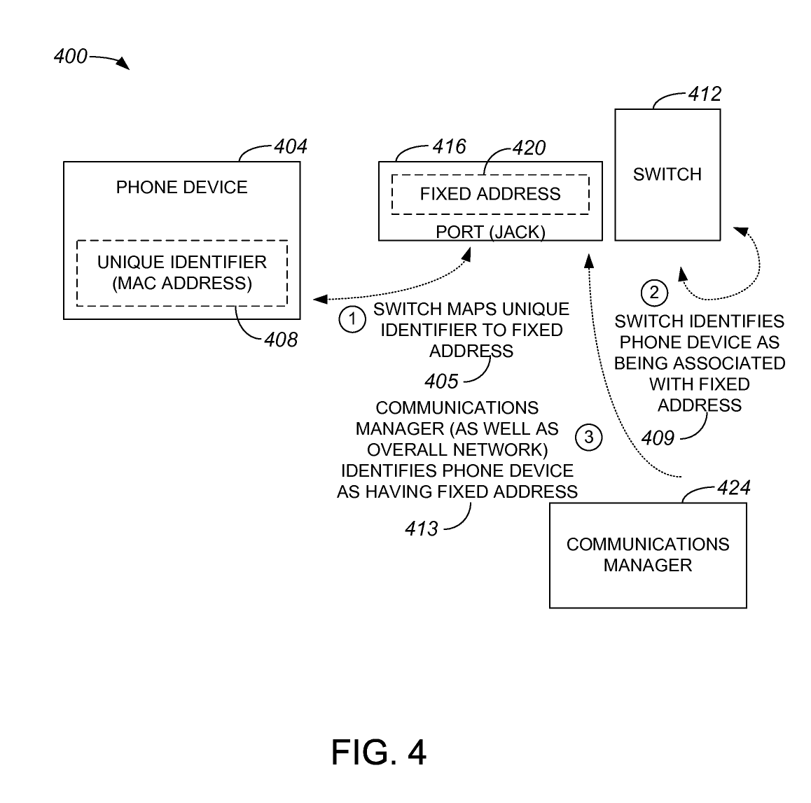

Referring next to FIG. 4, a process of incorporating a phone device with a unique identifier into an overall network substantially automatically, e.g., substantially without having to manually provision the device, will be described in accordance with an embodiment. A network 400, as for example a VoIP network, includes a phone device 404, a switch 412, a port 416, and a communications manager 424. Phone device 404, which may be a VoIP phone device, has a unique identifier 408. Unique identifier 408, which is arranged to uniquely identify VoIP phone device, may be a MAC address. Switch 412 is associated with a port arrangement 416, and cooperates with communications manager 424 to enable other devices (not shown) within network 400 to communicate with phone device 404. Port arrangement 416 has a fixed address 420 that uniquely identifies port arrangement 416.

When phone device 404 is first detected by switch 412 as being connected to port arrangement 416, switch 412 maps unique identifier 408 or, more generally, phone device 404 to fixed address 420, as indicated at action 405. Switch 412 is then able to identify phone device 404 as being associated with fixed address 420 at action 409. Finally, communications manager 424, as well as network 400 in general, identifies phone device 404 as being associated with fixed address 420 at action 413. Thus, unique identifier 408 is effectively not used within network 400 to identify phone device 404, as any phone device 404 that is connected to port arrangement 416 is identified within network 400 as having fixed address 420.

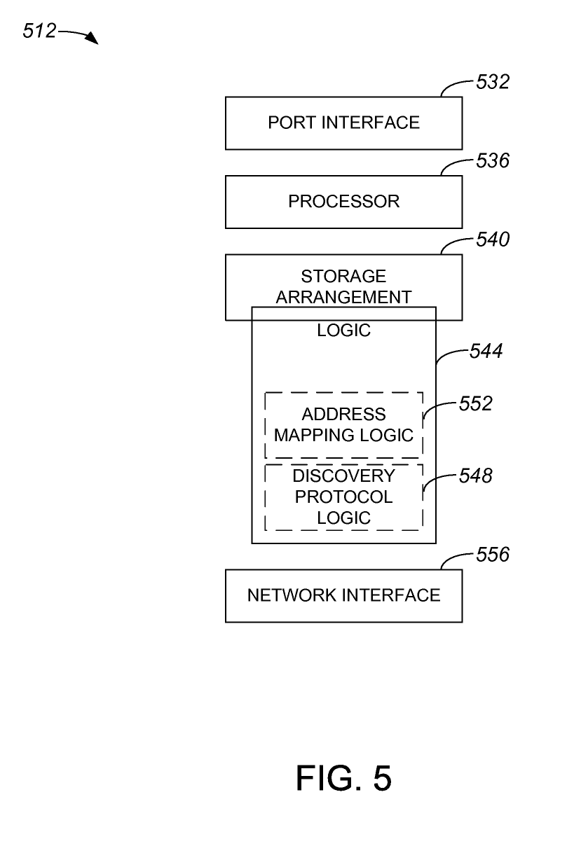

A switch such as switch 112 of FIG. 1 or switch 412 of FIG. 4 generally detects the presence of a new phone device that is substantially connected to a port associated with the switch, and anchors the new phone device to the port such that the fixed address of the port, rather than a unique identifier of the new phone device, is used to identify the new phone device within a network. FIG. 5 is a block diagram representation of one switch that is capable of mapping a device with a unique identifier to a fixed port address in accordance with an embodiment. A switch 512 includes a port interface 532. In one embodiment, port interface 532 is configured to interface with a port (not shown), e.g., a jack, to which a phone device (not shown) may be connected. It should be appreciated, however, that in some embodiments, port interface 532 may instead include a port (not shown) to which a phone device (not shown) may be connected.

A processor 536 is configured to executed logic 544 that may be stored in a storage arrangement 540. Storage arrangement 540 may be any suitable memory, and in addition to storing logic 544, storage arrangement 540 may store data structures including, but not limited to including, data structures that identify a device group of switch 512.

Logic 544 may generally include hardware and/or software logic. Logic 544 includes, but is not limited to including, discovery protocol logic 548 and address mapping logic 552. Discovery protocol logic 548 is configured to detect a presence of a phone device (not shown), as for example a VoIP phone device, that is in communication with port interface 532. In one embodiment, discovery protocol logic 548 is logic that implements a CDP. Address mapping logic 552 is arranged to map a detected phone device (not shown) to a fixed address of a port (not shown) to which the phone device is connected. That is, address mapping logic 552 is configured to anchor a phone device (not shown) to a port (not shown) such that the phone device may be substantially identified within a network as having the fixed address of the port. As a result, the unique address of the phone device (not shown) may remain substantially invisible within the network.

A network interface 556 is arranged to allow switch 512 to communicate with components within a network, as for example a communications manager (not shown). One suitable communications manager may be a Unified Communications Manager, which is available from Cisco Systems, Inc. of San Jose, Calif. Although network interface 556 and port interface 532 are shown as substantially separate components, it should be appreciated that port interface 532 may be included as a part of network interface 556.

Although only a few embodiments have been described in this disclosure, it should be understood that the disclosure may be embodied in many other specific forms without departing from the spirit or the scope of the present disclosure. By way of example, while a device that is mapped to a fixed address of a port, or anchored to a port, has generally been described as a phone device, a device that is mapped to a fixed address is not limited to being a phone device. In other words, substantially any suitable device or endpoint may be mapped to a fixed address of a port.

The identification of devices of the same type using a single address, e.g., an address of a port to which the devices may be connected, facilitates the deployment of devices within a network. In general, when a first device deployed on a particular port is replaced with a new device, the new device may effectively be deployed such that the new device “looks like” the first device, as both devices may be identified using the address of the particular port. Thus, a single address such as a MAC address of a port within a VoIP environment may be used to identify substantially any suitable device that is coupled to the port.

In one embodiment, a switch may determine whether an endpoint is associated with a device group that enables the switch to map a unique address of the endpoint to a fixed address of a port on which the endpoint is essentially detected. It should be appreciated, however, that in lieu of making such a determination, a switch may instead substantially assume that the endpoint supports being identified by a fixed address of a port.

A phone device or, more generally, an endpoint has been described as being connected to a port, e.g., a jack, that has a fixed address. While such an endpoint may be physically connected to a port, the endpoint may be substantially connected to the port without being physically connected to the port. For example, an endpoint may be communicably coupled to the port such that the endpoint communicates with the port in a substantially wireless manner.

The embodiments may be implemented as hardware and/or software logic embodied in a tangible medium that, when executed, is operable to perform the various methods and processes described above. That is, the logic may be embodied as physical arrangements or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
detecting a presence of a first endpoint on a port, the port being associated with a switch that is part of a network, the switch being arranged to support a first type, wherein the port has a fixed address;
determining when the first endpoint is of the first type after detecting the presence of the first endpoint on the port; and
mapping the first endpoint to the fixed address when it is determined that the endpoint is of the first type, wherein mapping the endpoint to the fixed address includes identifying the first endpoint by the fixed address within the network.

2. The method of claim 1 wherein the first endpoint is an Internet Protocol (IP) endpoint and the network is an IP environment.

3. The method of claim 2 wherein the first endpoint is a Voice over IP (VoIP) phone device.

4. The method of claim 1 wherein mapping the first endpoint to the fixed address includes mapping a unique identifier of the first endpoint into a content addressable memory of the switch based on the fixed address.

5. The method of claim 1 further including:
detecting a removal of a second endpoint from the port, the second endpoint being identified within the network by the fixed address, wherein the presence of the first endpoint on the port is detected after the removal of the second endpoint from the port is detected.

6. The method of claim 1 wherein the network includes a communications manager, and wherein mapping the first endpoint to the fixed address includes causing the communications manager to identify the first endpoint as having the fixed address.

7. The method of claim 1 wherein identifying the first endpoint by the fixed address allows the first endpoint to be automatically recognized within the network as having the fixed address.

8. The method of claim 1 wherein detecting the presence of the first endpoint on the port includes utilizing a discovery protocol to detect the presence of the first endpoint on the port.

9. A tangible, non-transitory computer-readable medium comprising computer program code, the computer program code, when executed, configured to:
detect a presence of a first endpoint on a port, the port being associated with a switch that is part of a network, the switch being arranged to support a first type, wherein the port has a fixed address;
determine when the first endpoint is of the first type after detecting the presence of the first endpoint on the port; and
map the first endpoint to the fixed address when it is determined that the endpoint is of the first type, wherein the computer program code configured to map the endpoint to the fixed address is configured to identify the first endpoint by the fixed address within the network.

10. The tangible, non-transitory computer-readable medium of claim 9 wherein the first endpoint is an Internet Protocol (IP) endpoint and the network is an IP environment.

11. The tangible, non-transitory computer-readable medium of claim 10 wherein the first endpoint is a Voice over IP (VoIP) phone device.

12. The tangible, non-transitory computer-readable medium of claim 9 wherein the computer program code configured to map the first endpoint to the fixed address is further configured to map a unique identifier of the first endpoint into a content addressable memory of the switch based on the fixed address.

13. The tangible, non-transitory computer-readable medium of claim 9 wherein the computer program code is further configured to:
detect a removal of a second endpoint from the port, the second endpoint being identified within the network by the fixed address, wherein the presence of the first endpoint on the port is detected after the removal of the second endpoint from the port is detected.

14. The tangible, non-transitory computer-readable medium of claim 9 wherein the network includes a communications manager, and wherein the computer program code operable to map the first endpoint to the fixed address is further operable to cause the communications manager to identify the first endpoint as having the fixed address.

15. The tangible, non-transitory computer-readable medium of claim 9 wherein the computer program code operable to identify the first endpoint by the fixed address is further operable to cause the first endpoint to be automatically recognized within the network as having the fixed address.

16. The tangible, non-transitory computer-readable medium of claim 9 wherein the computer program code operable to detect the presence of the first endpoint on the port is further operable to utilize a discovery protocol to detect the presence of the first endpoint on the port.

17. An apparatus comprising:
a port interface;
means detecting a presence of a first endpoint on a port, the port being a part of a network and associated with the port interface, the switch being arranged to support a first type, wherein the port has a fixed address;
means for determining when the first endpoint is of the first type after detecting the presence of the first endpoint on the port; and
means for mapping the first endpoint to the fixed address when it is determined that the endpoint is of the first type, wherein the means for mapping the endpoint to the fixed address include means for identifying the first endpoint by the fixed address within the network.

18. An apparatus comprising:
a processor;
a port arrangement, the port arrangement having an associated fixed address;
an interface to a network; and
logic arranged to cooperate with the processor to detect a presence of an endpoint on the port arrangement using a discovery protocol, the endpoint having a unique address, the logic further being arranged to map the endpoint to the fixed address and to cause the endpoint to be identified in the network by the fixed address when the presence of the endpoint on the port arrangement is detected.

19. The apparatus of claim 18 wherein the network is a Voice over Internet Protocol (VoIP) network and the endpoint is a VoIP phone device.

20. The apparatus of claim 18 further including:
a content addressable memory, wherein the logic arranged to map the endpoint to the fixed address is further arranged to map the unique address of the first endpoint into the content addressable memory based on the fixed address.
